(19) United States
(12) Patent Application Publication
(10) Pub. No.: US 2024/0396686 A1
(43) Pub. Date: Nov. 28, 2024

(54) POSITIONING IN NEW RADIO, NR, SPECTRA AND NR-UNLICENSED, NR-U, SPECTRA

(71) Applicant: Nokia Technologies Oy, Espoo (FI)

(72) Inventors: Oana-Elena BARBU, Aalborg (DK); Benny VEJLGAARD, Gistrup (DK); Johannes HARREBEK, Aalborg (DK)

(73) Assignee: Nokia Technologies Oy, Espoo (FI)

(21) Appl. No.: 18/695,990

(22) PCT Filed: Oct. 1, 2021
(86) PCT No.: PCT/EP2021/077101

§ 371 Date: Mar. 27, 2024

(51) Int. Cl. H04L 5/00; H04W 64/00

(52) U.S. Cl. CPC H04L 5/005; H04W 64/00

(57) ABSTRACT

Certain examples of the present disclosure relate to positioning, for example positioning in New Radio, NR, spectra and NR-Unlicensed, NR-U, spectra. Certain examples provide apparatus (10) comprising means (12,13) for: receiving configuration information (406₁, 406₂), wherein the configuration information comprises information for configuring a transmission or a reception, by the apparatus to or from at least one node a Radio Access Network, RAN, (110, 120) of a set of Reference Signals, RSs (409₁); wherein the set of RSs comprises: at least a first RS (NR RS) to be transmitted or received within a first frequency range, and at least a second RS (NR-U RS) to be transmitted or received within a second frequency range, and based at least in part on the configuration information, causing the transmission or the reception of the set of RSs to or from the at least one node of the RAN.

### TECHNOLOGICAL FIELD

Examples of the present disclosure relate to positioning. Some examples, though without prejudice to the foregoing, relate to positioning in New Radio, NR, spectra and NR-Unlicensed, NR-U, spectra.

### BACKGROUND

A wireless network (e.g., a Next Generation Radio Access Network, NG-RAN) comprises a plurality of network nodes including: terminal nodes (e.g., User Equipment, UE) and access nodes (e.g., Transmission Reception Points, TRPs, such as gNodeBs, gNBs), wherein communication between the terminal nodes and access nodes is wireless.

A position of a UE within a RAN can be determined by a Location Management Function, LMF, by various network-based positioning techniques, such as using LTE Positioning Protocol, LPP, or New Radio Positioning Protocol, NRPP. A conventional framework for positioning in 5^{th} Generation, 5G, NR (i.e., to determine the position of the UE—either via an Uplink, UL, positioning procedure or a Downlink, DL, positioning procedure) involves the transmission, in the NR spectra (i.e., frequency bands/ranges licensed for use by the NG-RAN), of Sounding Reference Signals, SRS, transmitted by the UE for UL positioning; or Position Reference Signals, PRS, transmitted by TRPs/gNBs for DL positioning. Such Reference Signals, RSs, are received, detected and measured by the TRPs/gNBs (for UL positioning) or the UE (for DL positioning). The LMF, receives the measurements from the TRPs/gNBs or the UE and uses the measurements to compute the position of the UE.

In some circumstances it may be desirable to provide an improved apparatus and method for positioning. In some circumstances it may be desirable to improve positioning accuracy. In some circumstances it may be desirable to reduce positioning latency.

The listing or discussion of any prior-published document or any background in this specification should not necessarily be taken as an acknowledgement that the document or background is part of the state of the art or is common general knowledge. One or more aspects/examples of the present disclosure may or may not address one or more of the background issues.

### BRIEF SUMMARY

The scope of protection sought for various embodiments of the invention is set out by the claims.

According to various, but not necessarily all, examples of the disclosure there are provided examples as claimed in the appended claims. Any examples and features described in this specification that do not fall under the scope of the independent claims are to be interpreted as examples useful for understanding various embodiments of the invention.

According to at least some examples of the disclosure there is provided an apparatus comprising means for:
receiving configuration information, wherein the configuration information comprises information for configuring a transmission or a reception, by the apparatus to or from at least one node a Radio Access Network, RAN, of a set of Reference Signals, RSs; wherein the set of RSs comprises:
   at least a first RS to be transmitted or received within a first frequency range, and
   at least a second RS to be transmitted or received within a second frequency range; and
based at least in part on the configuration information, causing the transmission or the reception of the set of RSs to or from the at least one node of the RAN.

According to various, but not necessarily all, examples of the disclosure there is provided a method comprising:
receiving configuration information, wherein the configuration information comprises information for configuring a transmission or a reception, by the apparatus to or from at least one node a Radio Access Network, RAN, of a set of Reference Signals, RSs; wherein the set of RSs comprises:
   at least a first RS to be transmitted or received within a first frequency range, and
   at least a second RS to be transmitted or received within a second frequency range; and
based at least in part on the configuration information, causing the transmission or the reception of the set of RSs to or from the at least one node of the RAN.

According to various, but not necessarily all, examples of the disclosure there is provided computer program instructions for causing an apparatus to perform:
receiving configuration information, wherein the configuration information comprises information for configuring a transmission or a reception, by the apparatus to or from at least one node a Radio Access Network, RAN, of a set of Reference Signals, RSs; wherein the set of RSs comprises:
   at least a first RS to be transmitted or received within a first frequency range, and
   at least a second RS to be transmitted or received within a second frequency range; and
based at least in part on the configuration information, causing the transmission or the reception of the set of RSs to or from the at least one node of the RAN.

According to various, but not necessarily all, examples of the disclosure there is provided an apparatus comprising:
at least one processor; and
at least one memory including computer program instructions;
the at least one memory and the computer program instructions configured to, with
the at least one processor, cause the apparatus at least to perform:
receiving configuration information, wherein the configuration information comprises information for configuring a transmission or a reception, by the apparatus to or from at least one node a Radio Access Network, RAN, of a set of Reference Signals, RSs; wherein the set of RSs comprises:
at least a first RS to be transmitted or received within a first frequency range, and
at least a second RS to be transmitted or received within a second frequency range; and
based at least in part on the configuration information, causing the transmission or the reception of the set of RSs to or from the at least one node of the RAN.

According to various, but not necessarily all, examples of the disclosure there is provided a non-transitory computer readable medium encoded with instructions that, when performed by at least one processor, causes at least the following to be perform:
receiving configuration information, wherein the configuration information comprises information for configuring a transmission or a reception, by the apparatus to or from at least one node a Radio Access Network, RAN, of a set of Reference Signals, RSs; wherein the set of RSs comprises:
   at least a first RS to be transmitted or received within a first frequency range, and
   at least a second RS to be transmitted or received within a second frequency range; and
based at least in part on the configuration information, causing the transmission or the reception of the set of RSs to or from the at least one node of the RAN.

According to at least some examples of the disclosure there is provided a Location Server, LS, comprising means for:
determining configuration information, wherein the configuration information comprises information for configuring a transmission or a reception, by an apparatus to or from at least one node a Radio Access Network, RAN, of a set of Reference Signals, RSs; wherein the set of RSs comprises:
   at least a first RS to be transmitted or received within a first frequency range, and
   at least a second RS to be transmitted or received within a second frequency range, causing transmission of the configuration information to the apparatus.

According to various, but not necessarily all, examples of the disclosure there is provided a method comprising:

According to various, but not necessarily all, examples of the disclosure there is provided computer program instructions for causing an apparatus to perform:
determining configuration information, wherein the configuration information comprises information for configuring a transmission or a reception, by an apparatus to or from at least one node a Radio Access Network, RAN, of a set of Reference Signals, RSs; wherein the set of RSs comprises:
   at least a first RS to be transmitted or received within a first frequency range, and
   at least a second RS to be transmitted or received within a second frequency range. causing transmission of the configuration information to the apparatus.

According to various, but not necessarily all, examples of the disclosure there is provided an apparatus comprising:
at least one processor; and
at least one memory including computer program instructions;
the at least one memory and the computer program instructions configured to, with
the at least one processor, cause the apparatus at least to perform:
determining configuration information, wherein the configuration information comprises information for configuring a transmission or a reception, by an apparatus to or from at least one node a Radio Access Network, RAN, of a set of Reference Signals, RSs; wherein the set of RSs comprises:
at least a first RS to be transmitted or received within a first frequency range, and
at least a second RS to be transmitted or received within a second frequency range. causing transmission of the configuration information to the apparatus.

According to various, but not necessarily all, examples of the disclosure there is provided a non-transitory computer readable medium encoded with instructions that, when performed by at least one processor, causes at least the following to be perform: determining configuration information, wherein the configuration information comprises information for configuring a transmission or a reception, by an apparatus to or from at least one node a Radio Access Network, RAN, of a set of Reference Signals, RSs; wherein the set of RSs comprises:
at least a first RS to be transmitted or received within a first frequency range, and
at least a second RS to be transmitted or received within a second frequency range. causing transmission of the configuration information to the apparatus.

The following portion of this ‘Brief Summary’ section describes various features that can be features of any of the examples described in the foregoing portion of the ‘Brief Summary’ section. The description of a function should additionally be considered to also disclose any means suitable for performing that function.

In some but not necessarily all examples, the at least first RS and/or the at least second RS is at least one selected from a group of:
an RS configured for use in determining a position of a User Equipment, UE, of the RAN;
a downlink, DL, RS;
a Positioning Reference Signal, PRS;
an uplink, UL, RS; and
a Sounding Reference Signal, SRS.

In some but not necessarily all examples, wherein the first frequency range is within at least one selected from a group of:
a frequency range or band licensed for use by the RAN;
a frequency range or band of a New Radio, NR, spectrum;
a frequency range or band licensed for 5th Generation, 5G, NR;
a frequency range or band where access to the frequency range or band is planned and/or cannot be accessed opportunistically; and
a frequency range or band where a performance of a Listen Before Talk, LBT, procedure is not required for a transmission therein.

In some but not necessarily all examples, the second frequency range is within at least one selected from a group of:
a frequency range or band unlicensed for use by the RAN;
a frequency range or band of a New Radio Unlicensed, NR-U, spectrum;
a frequency range or band not licensed for 5th Generation, 5G, NR;
a frequency range or band where access to the frequency range or band is unplanned and/or is accessed opportunistically; and
a frequency range or band where a performance of a Listen Before Talk, LBT, protocol is required for a transmission therein.

In some but not necessarily all examples, the configuration information comprises an indication of first information for enabling the apparatus to determine at least one selected from a group of:
resources for the at least one first RS and the at least one second RS of the set of RSs;
a time, a frequency, a space, and/or a code for use with the at least one first RS and the at least one second RS of the set of RSs;
a pattern, a sequence, an order and/or an interleaving of the at least one first RS and the at least one second RS of the set of RSs;
a Listen Before Talk, LBT, protocol to implement for the transmission of the at least one second RS of the set of RSs;
a number of repetitions of the transmission or reception of the set of RSs; and
a periodicity of repetitions of the transmission or reception of the set of RSs.

In some but not necessarily all examples, the configuration information comprises an indication of second information for enabling the apparatus to determine at least one selected from a group of the following parameters to be use for the transmission or reception of the at least first and/or second RS:
a sequence type;
a carrier frequency;
a time offset;
a bandwidth;
a frequency offset;
a repetition pattern;
a period and;
a comb.

In some but not necessarily all examples, the apparatus further comprises means for, responsive to receipt of a trigger, causing the transmission or the reception of the set of RSs to or from the at least one node of the RAN in accordance with the configuration information.

In some but not necessarily all examples, the configuration information comprises: information for defining one or more first dedicated time periods within a time period in which the set of RSs is scheduled to be transmitted or received; and information for configuring the apparatus to be able to receive, during the one or more first dedicated time periods, an indicator indicative of an instruction.

In some but not necessarily all examples, the indicator is indicative of a continuation instruction or a termination instruction, and wherein the apparatus further comprises means, responsive to receiving the indication during the one or more first dedicated time periods, for continuing or terminating at least one selected from a group of:
the transmission of the set of RSs or one or more RSs of the set of RSs;
the reception of the set of RSs or one or more RSs of the set of RSs; and measurement of the set of RSs or one or more RSs of the set of RSs.

In some but not necessarily all examples, the configuration information comprises: information for defining one or more second dedicated time periods within a time period in which the set of RSs is scheduled to be transmitted or received; and information for configuring the apparatus to transmit, during the one or more second dedicated time periods, one or more measurements of one or more received RSs of the set of RSs.

In some but not necessarily all examples, the apparatus further comprises means, responsive at least in part to receiving the configuration information, for transmitting the one or more measurements during the one or more second dedicated time periods.

In some but not necessarily all examples, the apparatus further comprises means for:
causing transmission of capability information, wherein the capability information comprises an indication of a capability of the apparatus to transmit and/or receive signals at the first and/or second frequency ranges.

In some but not necessarily all examples, causing the transmission of the capability information is based at least in part on receiving a request for the capability information.

In some but not necessarily all examples, the configuration information is configured based at least in part on the capability information.

In some but not necessarily all examples, the apparatus further comprises means for:
causing transmission of information indicative of spectrum utilization information.

In some but not necessarily all examples, the apparatus further comprises means for:
causing transmission of information indicative of positioning Quality of Service, QoS, requirements.

In some but not necessarily all examples, the configuration information is received from at least one selected from a group of:
a Location Server, LS;
a node of the RAN;
an access node;
a core node;
a relay node; and
a sidelink UE.

In some but not necessarily all examples, the apparatus further comprises means for:
decoding one or more of: the at least first and/or second RSs of the set of RSs; measuring one or more of: the at least first and/or second RSs of the set of RSs; and/or
reporting one or more measurement results of one or more measurements performed on one or more of: the at least first and/or second RSs of the set of RSs.

In some but not necessarily all examples, the apparatus selected from a group of:
a node of the RAN;
a User Equipment, UE;
an access node of the RAN; and
a Transmission and Reception Point, TRP.

In some but not necessarily all examples, the LS further comprises means for:
receiving, from the at least one node of the RAN, information indicative of one or more measurements performed on one or more of: the at least first and/or second RSs of the set of RSs; and
determining a position based at least in part on the received one or more measurements.

In some but not necessarily all examples, the LS further comprises means for:
receiving capability information, wherein the capability information comprises an indication of the capability of the apparatus to transmit and/or receive signals at the first and/or second frequency ranges;
receiving information indicative of spectrum load information; and/or
receiving information indicative of positioning Quality of Service, QoS, requirements.

In some but not necessarily all examples, the LS further comprises means for determining the configuration information based at least in part on:
the capability information;
the information indicative of spectrum load information; and/or
the information indicative of positioning Quality of Service, QoS, requirements.

In some but not necessarily all examples, the LS further comprising means for:
causing transmission of configuration information for configuring a time period within which the apparatus is to transmit the UWB RS to the at least one node of the RAN.

In some but not necessarily all examples, the configuration information comprises:
information for defining one or more first dedicated time periods within a time period in which the set of RSs is scheduled to be transmitted or received; and
information for configuring the apparatus to be able to receive an indicator, during the one or more first dedicated time periods, indicative of a continuation instruction or a termination instruction.

In some but not necessarily all examples, the LS further comprises means for:
causing transmission of the indicator during the one or more first dedicated time periods.

In some but not necessarily all examples, the configuration information comprises:
information for defining one or more second dedicated time periods within a time period in which the set of RSs is scheduled to be transmitted or received; and
information for configuring the apparatus to transmit, during the one or more second dedicated time periods, one or more measurements of one or more received RSs of the set of RSs.

In some but not necessarily all examples, the LS further comprises means for:
receiving, the from at least one node of the RAN, a first measurement result of an RS of a sequence of RSs of the set of RSs;
determining a position based at least in part on the received first measurement result;
receiving, the from at least one node of the RAN, a second measurement result of a next RS of the sequence of RSs of the set of RSs;
determining an updated position based at least in part on the received first and second measurement results;
determining whether the updated position is a refinement of the first position; and
determining whether to use the second measurement result and/or the updated position based on the determination whether the updated position is a refinement of the first position.

In some but not necessarily all examples, causing transmission of the indicator during the one or more first dedicated time periods is based, at least in part, on the determination whether the updated position is a refinement of the first position.

### BRIEF DESCRIPTION OF THE DRAWINGS

Some examples will now be described with reference to the accompanying drawings in which:

FIG. 1 shows an example of the subject matter described herein;

FIG. 2 shows another example of the subject matter described herein;

FIG. 3 shows another example of the subject matter described herein;

FIG. 4 shows another example of the subject matter described herein;

FIG. 5 shows another example of the subject matter described herein;

FIG. 6 shows another example of the subject matter described herein; and

FIG. 7 shows another example of the subject matter described herein.

The figures are not necessarily to scale. Certain features and views of the figures can be shown schematically or exaggerated in scale in the interest of clarity and conciseness. For example, the dimensions of some elements in the figures can be exaggerated relative to other elements to aid explication. Similar reference numerals are used in the figures to designate similar features. For clarity, all reference numerals are not necessarily displayed in all figures.

In the drawings (and description) a similar feature may be referenced by the same three-digit number. In the drawings (and description), an optional subscript to the three-digit number can be used to differentiate different instances of similar features. Therefore, a three-digit number without a subscript can be used as a generic reference and the three-digit number with a subscript can be used as a specific reference. A subscript can comprise a single digit that labels different instances. A subscript can comprise two digits including a first digit that labels a group of instances and a second digit that labels different instances in a group.

### ABBREVIATIONS/DEFINITIONS

3GPP Third Generation Partnership Project
5G 5^{th} Generation
AOA Angle Of Arrival (receiver side)
AOD Angle Of Departure (transmitter side)
gNB gNodeB
LBT Listen Before Talk
LMF Location Management Function
LPP LTE Positioning Protocol
LTE Long-Term Evolution
NG Next Generation
NR New Radio
NR-U NR Unlicensed
NRPPa New Radio Positioning Protocol Annex
OTDOA Observed Time Difference Of Arrival
PRS Positioning Reference Signal
RAN Radio Access Network
RSTD Reference Signal Time Difference
SRS Sounding Reference Signal
TOA Time Of Arrival
TDOA Time Difference Of Arrival
TRP Transmission Reception Point
UE User Equipment

### DETAILED DESCRIPTION

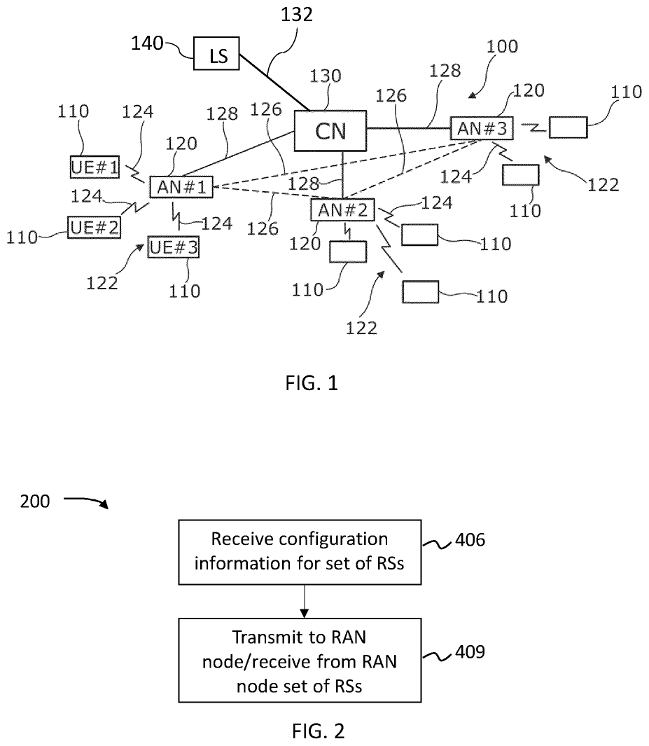

FIG. 1 schematically illustrates an example of a network 100 comprising a plurality of network nodes including terminal nodes 110 (also referred to as User Equipment, UE), access nodes 120 (also referred to as Transmission Reception Points, TRPs), one or more core nodes 130 and one or more location servers 140. The terminal nodes 110 and access nodes 120 communicate with each other. The access nodes 120 may communicate with the location server 140 via the one or more core nodes 130. The access nodes 120 and one or more location servers 140 may communicate directly with each other. The one or more core nodes 130 may, in some but not necessarily all examples, communicate with each other. The one or more access nodes 120 may, in some but not necessarily all examples, communicate with each other.

The network 100 is in this example a radio telecommunications network, i.e., a Radio Access Network, RAN, in which at least some of the terminal nodes 110 and access nodes 120 communicate with each other using transmission/reception of radio waves.

The RAN 100 may be a cellular network comprising a plurality of cells 122 each served by an access node 120. The access nodes 120 comprise cellular radio transceivers. The terminal nodes 110 comprise cellular radio transceivers.

In the particular example illustrated, the network 100 is a Next Generation (NG) or New Radio (NR) network. NR is the Third Generation Partnership Project (3GPP) name for fifth generation, 5G, technology.

The interfaces between the terminal nodes 110 and the access nodes 120 are radio interfaces 124 (e.g., Uu interfaces). The interfaces between the access nodes 120 and one or more core nodes 130 are backhaul interfaces 128 (e.g., S1 and/or NG interfaces). The interfaces between the one or more location servers 140 and the one or more core nodes 130 are backhaul interface 132 (e.g., NLs interface).

Depending on the exact deployment scenario, the access nodes 120 can be RAN nodes such as NG-RAN nodes. NG-RAN nodes may be gNodeBs (gNBs) that provide NR user plane and control plane protocol terminations towards the UE. NG-RAN nodes may be New Generation Evolved Universal Terrestrial Radio Access network (E-UTRAN) NodeBs (ng-eNBs) that provide E-UTRA user plane and control plane protocol terminations towards the UE. The gNBs and ng-eNBs may be interconnected with each other by means of Xn interfaces. The gNBs and ng-eNBs are also connected by means of NG interfaces to the 5G Core (5GC), more specifically to the AMF (Access and Mobility management Function) by means of an NG control plane (NG-C) interface and to the UPF (User Plane Function) by means of an NG user plane (NG-U) interface. The access nodes 120 may be interconnected with each other by means of Xn interfaces 126.

The cellular network 100 could be configured to operate in licensed frequency bands, referred to herein as NR spectra, or unlicensed frequency bands, referred to herein as NR-U spectra (not least such as: unlicensed bands that rely upon a transmitting device to sense the radio resources/medium before commencing transmission, such as via a Listen Before Talk (LBT) procedure; and a 60 GHz unlicensed band where beamforming may be required in order to achieve required coverage).

The access nodes 120 can be deployed in a NR standalone operation/scenario. The access nodes 120 can be deployed in a NR non-standalone operation/scenario. The access nodes can be deployed in a Carrier Aggregation operation/scenario. The access nodes 120 can be deployed in a dual connectivity operation/scenario, i.e., Multi Radio Access Technology-Dual Connection (MR-DC), not least for example such as:
Evolved Universal Terrestrial Radio Access-New Radio Dual Connectivity (EUTRA-NR-DC, also referred to as EN-DC),
New Radio-Evolved Universal Terrestrial Radio Access Dual Connectivity (NR-EUTRA-DC, also referred to as NE-DC),
Next Generation Radio Access Network Evolved Universal Terrestrial Radio Access-New Radio Dual Connectivity (NG-RAN E-UTRA-NR Dual Connectivity, also referred to as NGEN-DC), or
New Radio Dual Connectivity (also referred to as NR-DC).

In such non-standalone/dual connectivity deployments, the access nodes 120 may be interconnected to each other by means of X2 or Xn interfaces, and connected to an Evolved Packet Core (EPC) by means of an S1 interface or to the 5GC by means of a NG interface.

The terminal nodes 110 are network elements in the network that terminate the user side of the radio link. They are devices allowing access to network services. The terminal nodes 110 may be referred to as User Equipment (UE), mobile terminals or mobile stations. The term ‘User Equipment’ may be used to designate mobile equipment comprising a smart card for authentication/encryption etc such as a Subscriber Identity Module (SIM). In other examples, the term ‘User Equipment’ is used to designate a location/position tag, a hyper/smart tag or a mobile equipment comprising circuitry embedded as part of the user equipment for authentication/encryption such as software SIM.

The access nodes 120 are network elements in the network responsible for radio transmission and reception in one or more cells 122 to or from the terminal nodes 110. Such access nodes may also be referred to as a Transmission Reception Points (TRPs) or base stations. The access nodes 120 are the network termination of a radio link. An access node 120 can be implemented as a single network equipment, or have a split architecture that is disaggregated/distributed over two or more RAN nodes, such as a Central Unit (CU), a Distributed Unit (DU), a Remote Radio Head-end (RRH), using different functional-split architectures and different interfaces.

Where the access node 120 has a disaggregated (split) architecture, the access node 120 can comprise one or more distributed units (gNB-DU) and a centralized unit (gNB-CU)—not shown in FIG. 1. The gNB-CU is a logical node configured to host a Radio Resource Connection (RRC) layer and other layers of the access node 120. The gNB-CU controls the operation of one or more gNB-DUs. The gNB-DU is a logical node configured to host Radio Link Control (RLC) protocol layer, Medium Access Control (MAC) layer and Physical (PHY) layer of the access node 120. The gNB-DU communicates via a dedicated interface (F1) to the RRC layer hosted by the gNB-CU. One gNB-DU can support one or multiple cells 122, whereas one cell is supported by only one gNB-DU 220.

The location server 140 is a device that manages the support of different location services for UEs, including positioning of UEs and delivery of assistance data to UEs. The location server can be connected to the core node and the Internet. The location server can be implemented as one or more servers. The location server is configured to support one or more location services for UEs 110 that can connect to the location server 140 via the core network 130 and/or via the Internet The location server may be referred to as Location Management Function (LMF). Where the location server resides in a RAN node, it may be referred to as a Location Management Component (LMC). The location server may interact with a serving RAN node for a UE in order to obtain position measurements for the UE, including uplink measurements made by a RAN node and downlink measurements made by the UE.

In the following description, a location server 140 will be referred to as an LS 140, an access node 120 will be referred to as a TRP 120 and a terminal node 110 will be referred to as a UE 110.

The position of a UE within a RAN can be determined by an LMF by various network-based positioning techniques (such as using LTE Positioning Protocol, LPP, or New Radio Positioning Protocol, NRPP). Conventional techniques involve the exchange, over a Uu interface in the NR spectra, of RSs (e.g., transmitting OFDM-PRSs from RAN nodes to a UE for DL positioning; and transmitting OFDM-SRSs from a UE to RAN nodes for UL positioning). Such Reference Signals, RSs, are received, detected and measured by the TRPs (for UL positioning) or the UE (for DL positioning). The LMF, receives the measurements from the TRPs or the UE. Such measurement information is received by the LMF via an Access and mobility Management Function, AMF, over a backhaul interface (e.g., NLs interface). The LMF then uses such received measurement information to compute the position of the UE. A NR Positioning Protocol A, NRPPa, carries positioning information between the NG-RAN nodes and the LMF over a NG control plane interface (e.g., NG-C interface).

Such Radio Access Technology, RAT, based positioning techniques may utilise one of the following methods: Uplink Angle of Arrival (UL-AoA), Downlink Angle of Departure (DL-AoD), Variance of Time of Arrival (TOA)-based ranging, Uplink Time Difference of Arrival (UL-TDOA), Downlink Time Difference of Arrival (DL-TDOA), and Multi-cell Round Trip Time (Multi-RTT).

The 5G NR localization process is standardized in the 5G NR LPP specification. A conventional positioning session relies on a receiver measuring positioning RSs (PRS in DL, and SRS in UL) which are scheduled by the network on specific time-frequency-space-code resources. The allocation of resources for such transmissions is coordinated across multiple UEs and TRPs via LPP and NRPPa interfaces, so that the RSs are ensured to be unique and interference free. This is done to enable the receiver (UE in DL and TRP in UL) to determine/compute/extract accurate positioning measurements which are reported back to the network (in case of UE-assisted positioning) or used locally (for UE-based positioning) to compute the UE location.

However, data traffic takes precedence over SRS/PRS scheduling. This means that the LS may need to wait until enough resources have been freed up in order to trigger a positioning session. In densely populated networks, this may yield both:
unacceptable delays (since Rel. 17 targets 100 ms latencies for a generic positioning session, and 10 ms latencies for Industrial Internet Of Things, IIoT), and
unacceptable accuracy (since the available bandwidth for PRS/SRS transmissions may prove insufficient to resolve, with acceptable resolution, a distance estimation. For example, Rel. 17 requires accuracy in the order of 10 cm for IIoT, which translates into a minimum required bandwidth of 3 GHz).

The accuracy problem is further exacerbated when a PRS/SRS transmission is interfered, since the PRS/SRS measurement process at the receiver becomes corrupted which renders the determination/computation/extraction of positioning measurements severely inaccurate. This can ultimately degrade the overall location estimation.

Examples of the present disclosure seek to mitigate such above-mentioned issues by accessing not only portions of the NR spectra but also portions of the NR-U spectra in a hybrid NR and NR-U PHY positioning session. As will be discussed in further detail below, examples of the disclosure define a joint positioning session, in which the LS uses the NR and NR-U spectra opportunistically and hierarchically e.g., when accuracy and latency requirements cannot be met with the standard approach (which defines positioning operation and PRS/SRS only in NR spectra, i.e., NR licensed bands).

It is desirable to provide accurate (e.g., cm level) positioning, especially in indoor scenarios, or outdoor scenarios with low Inter Site Distances, ISDs. It is desirable to provide positioning with latency.

Currently, there is no standard solution of including/integrating NR-U based positioning in 5G NR systems. Examples of the present disclosure may provide a hierarchical LPP session that merges NR and NR-U positioning signals transmission, reception, processing and reporting into a unified framework that allows the LS to recover the accuracy of an otherwise poor-quality positioning session.

FIG. 2 schematically illustrates a flow chart of an example of a method 200 according to an example of the present disclosure. One or more of the features discussed in relation to FIG. 2 can be found in one or more of the other FIGs. During discussion of FIG. 2, reference will be made to other FIGs for the purposes of explanation.

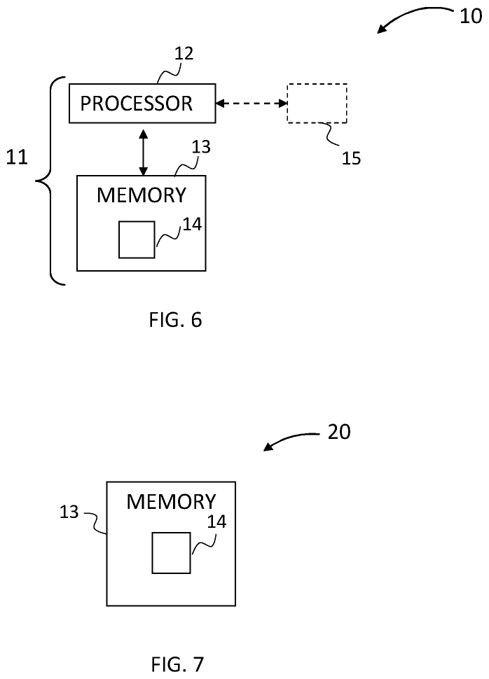

The component blocks of FIG. 2 are functional and the functions described can be performed by a single physical entity (such as an apparatus 10 as described with reference to FIG. 6, which may be implemented as a RAN node, such as a UE 110 or TRP 120, with transceiver functionality for transmitting and receiving both NR and NR-U transmissions, e.g., not least positioning RSs, [such as PRS/SRS] in the NR-U spectra). The functions described can also be implemented by a computer program (such as is described with reference to FIG. 7).

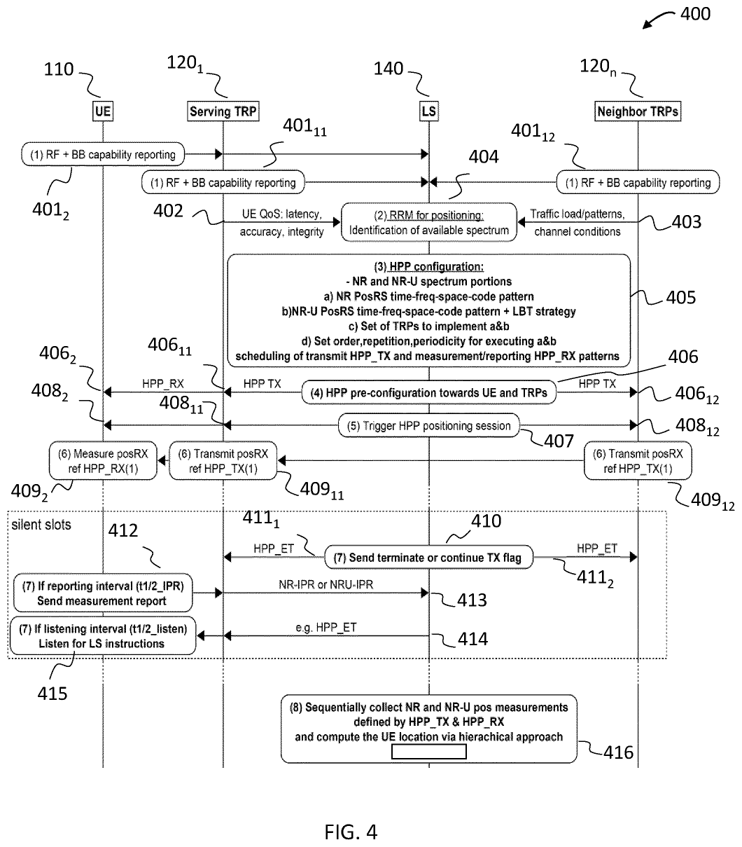

In block 406, configuration information (e.g., Hybrid Positioning Protocol, HPP, information as described below with respect to FIG. 4) is received by an apparatus 10 (e.g., a UE 110 or TRP 120 as described above with respect to FIG. 1). The configuration information comprises information for configuring a transmission or a reception, by the apparatus to or from at least one node of a RAN (e.g., one or more neighbouring TRPs and UEs), a set of Reference Signals, RSs (e.g., positioning RSs). The set of RSs comprises:
at least a first RS to be transmitted or received within a first frequency range (e.g., PRSs or SRSs transmitter or received over the NR spectrum), and
at least a second RS to be transmitted or received within a second frequency range (e.g., PRSs or SRSs transmitter or received over the NR-U spectrum).

In block 409, the set of RSs is caused to be transmitted to the at least one node of the RAN based at least in part on the received configuration information; or the set of RSs is received from the at least one node of the RAN based at least in part on the received configuration information.

In some examples, the RSs of the set of RSs are configured for determining a position of a UE in a RAN. In some examples, the RSs of the set of RSs are configured for use in DL positioning (e.g., the RSs are PRSs). In some examples, the RSs of the set of RSs are configured for use in UL positioning (e.g., the RSs are SRSs).

In some examples, the configuration information can provide information for enabling the apparatus to: generate and transmit the set of RSs. In some examples, the configuration information can provide information for enabling the apparatus to: receive, decode and/or measure the set of RSs.

In some examples, the configuration information is determined by an LS. In some examples, the LS causes the configuration information to be sent/transmitted to the apparatus. For instance, where the apparatus to be configured is a UE, the configuration information can be sent to the UE via LPP signaling; wherein the apparatus to be configured is a TRP, the configuration information can be sent to the TRP via NRPPa signaling.

In some examples, the at least first RS and/or the at least second RS is:
an RS configured for use in determining a position of a User Equipment, UE, of the RAN;
a downlink, DL, RS;
a Positioning Reference Signal, PRS;
an uplink, UL, RS; and/or
a Sounding Reference Signal, SRS.

In some examples, the first frequency range is within at least one selected from a group of:
a frequency range or band licensed for use by the RAN;
a frequency range or band of a New Radio, NR, spectrum;
a frequency range or band licensed for 5^{th} Generation, 5G, NR;
a frequency range or band where access to the frequency range or band is planned and/or cannot be accessed opportunistically; and
a frequency range or band wherein performance of a Listen Before Talk, LBT, procedure before a transmission in the frequency range or band is not required.

In some examples, the second frequency range is within at least one selected from a group of:
a frequency range or band unlicensed for use by the RAN;
a frequency range or band of a New Radio Unlicensed, NR-U, spectrum;
a frequency range or band not licensed for 5^{th} Generation, 5G, NR; and
a frequency range or band wherein performance of a Listen Before Talk, LBT, protocol before a transmission in the frequency range or band is required.

In some examples, the configuration information comprises an indication of information for enabling the apparatus to determine at least one selected from a group of:
resources for the at least one first RS and the at least one second RS of the set of RSs;
a time, a frequency, a space, and/or a code for use with the at least one first RS and the at least one second RS of the set of RSs;
a pattern, a sequence, an order and/or an interleaving of the at least one first RS and the at least one second RS of the set of RSs;
a Listen Before Talk, LBT, protocol to implement for the transmission of the at least one second RS of the set of RSs;
a number of repetitions of the transmission or reception of the set of RSs; and
a periodicity of repetitions of the transmission or reception of the set of RSs.

In some examples, the configuration information comprises an indication of information for enabling the apparatus to determine at least one selected from a group of the following parameters to be use for the transmission or reception of the at least first and/or second RS:
a sequence type;
a carrier frequency;
a time offset;
a bandwidth;
a frequency offset;
a repetition pattern;
a period; and
a comb.

In some examples, the apparatus further comprises means for, responsive to receipt of a trigger, causing the transmission or the reception of the set of RSs to or from the at least one node of the RAN in accordance with the received configuration information.

In some examples, the configuration information comprises:
information for defining one or more first dedicated time periods within a time period in which the set of RSs is scheduled to be transmitted or received; and
information for configuring the apparatus to be able to receive, during the one or more first dedicated time periods, an indicator indicative of an instruction (e.g., a continuation instruction or a termination instruction from the LS).

In some examples, the indicator is indicative of a continuation instruction or a termination instruction, and wherein the apparatus further comprises means, responsive to receiving the indication during the one or more first dedicated time periods, for continuing or terminating at least one selected from a group of:
the transmission of the set of RSs or one or more RSs of the set of RSs;
the reception of the set of RSs or one or more RSs of the set of RSs; and
measurement of the set of RSs or one or more RSs of the set of RSs.

In some examples, the configuration information comprises:
information for defining one or more second dedicated time periods within a time period in which the set of RSs is scheduled to be transmitted or received; and
information for configuring the apparatus to transmit, during the one or more second dedicated time periods, one or more measurements of one or more received RSs of the set of RSs.

In some examples, the apparatus further comprises means, responsive at least in part to receiving the configuration information, for transmitting the one or more measurements during the one or more second dedicated time periods.

In some examples, the apparatus further comprises means for causing transmission of capability information, wherein the capability information comprises an indication of a capability of the apparatus to transmit and/or receive signals at the first and/or second frequency ranges.

In some examples, causing transmission of the capability information is based at least in part on receiving a request for the capability information.

In some examples, the apparatus receives the configuration information based at least in part on the transmitted capability information.

In some examples, the apparatus further comprises means for:
causing transmission of information indicative of spectrum utilization information.

In some examples, the apparatus further comprises means for:
causing transmission of information indicative of positioning Quality of Service, QoS, requirements.

In some examples, the configuration information is received from at least one selected from a group of:
a Location Server, LS;
a node of the RAN;
an access node;
a core node;
a relay node; and
a sidelink UE.

In some examples, the apparatus further comprises means for:
decoding one or more of: the at least first and/or second RSs of the set of RSs;
measuring one or more of: the at least first and/or second RSs of the set of RSs; and/or
reporting one or more measurement results of one or more measurements performed on one or more of: the at least first and/or second RSs of the set of RSs.

In some examples, the apparatus is selected from a group of:
a node of the RAN;
a User Equipment, UE;
an access node of the RAN; and
a Transmission and Reception Point, TRP.

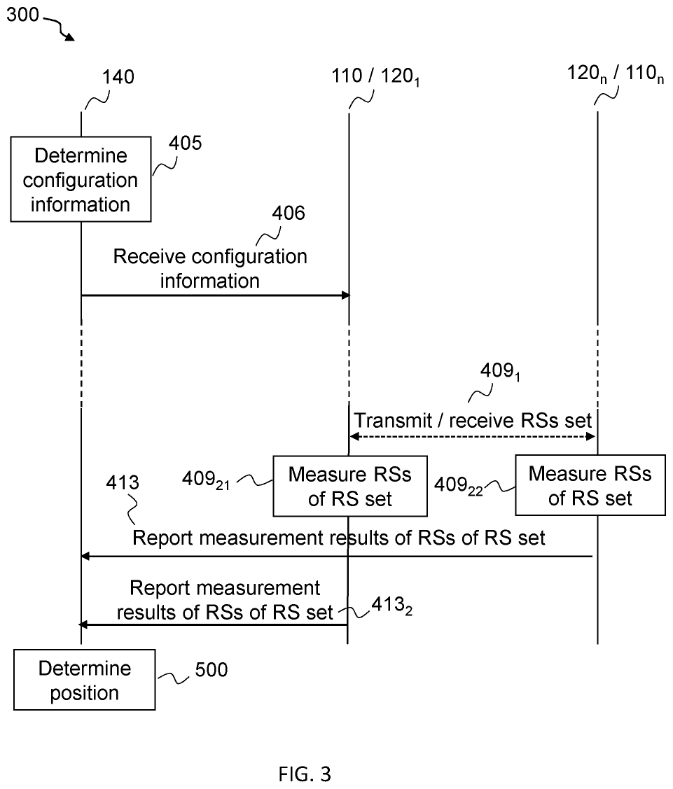

FIG. 3 schematically illustrates a flow chart of an example of a method 300.

One or more of the features discussed in relation to FIG. 3 can be found in one or more of the other FIGs. During discussion of FIG. 3, reference will be made to other FIGs for the purposes of explanation.

In some example, FIG. 3 can be considered to illustrate a plurality of methods. For instance, FIG. 3 illustrates one or more actions by/at a plurality of actors/entities (e.g., LS 140, UE 110 or serving TRP 120₁, and neighbouring TRPs 120ₙ or UEs 110ₙ). In some examples, FIG. 3 can be considered to illustrate a plurality of individual methods performed by each respective individual actor/entity of the plurality of the actors/entities.

In block 405, the LS 140 determines configuration information for configuring a UE 110 (i.e., for UL positioning) or TRP 120₁ (i.e., for DL position) to transmit, to neighbouring TRPs 120ₙ or UEs 110ₙ, of a set of RSs. The LS 140 can also determine configuration information for configuring the UE 110 (i.e., for DL positioning) or TRP 120₁ (i.e., for UL position) to receive, from neighbouring TRPs 120ₙ or UEs 110ₙ, of a set of RSs.

The set of RSs can comprise:
one or more first positioning RSs (e.g., PRS or SRS) to be transmitted or received within a first frequency range, i.e., transmitted or received within the NR licensed spectra. Such first RSs are referred to herein a “NR RS”; and
one or more second positioning RSs (e.g., PRS or SRS) to be transmitted or received within a second frequency range, i.e., transmitted or received within the NR unlicensed spectra. Such second RSs are referred to herein a “NR-U RS”.

Accordingly, the set of RSs may comprise a pattern/order/sequence of one or more NR RSs and one or more NR-U RSs, that may be interleaved with one another. For instance, the configured transmission of a set of RSs may be a configured scheduling for transmission of the following pattern, order and sequence of transmissions: NR RS, NR-U RS, NR-U RS. Similarly, a configured reception (and measurement) of the set of RSs may be a configured scheduling for reception (and measurement) of the following pattern, order and sequence of transmissions: NR RS, NR-U RS, NR-U RS. The set of RSs configured by the LS may thereby define a joint/hybrid positioning session, in which both the NR and NR-U spectra are utilised.

As will be discussed in further detail below, the determination of the configuration information (not least the number/order/sequence/pattern of NR RSs and NR-U RSs in the set of RSs) may be based at least in part on, for example, received: positioning QoS requirements (such as required accuracy, latency and/or integrity of the position), spectrum utilization information (such as traffic/cell load, power spectral density, channel condition information from the TRP).

The LS 140 sends the determined configuration information which is received by the UE 110 and/or TRP 120₁, as is shown with respect to messages 406₂, 406₁₁, and 406₁₂.

Subsequently, i.e., upon receiving a trigger (such as a positioning request or trigger 407 shown in FIG. 4), the UE 110 and/or TRP 120₁ (which have been pre-configured to transmit or receive the set of RSs via configuration information messages 406₁₁, 406₁₂ and 406₂), implements the transmission or reception of the set of RSs 409₁ in accordance with the configuration information. In the example of FIG. 4, the TRPs 120₁ and 120ₙ respectively transmit the set of RSs as is shown with respect to transmissions 409₁₁ and 409₁₂.

In blocks 409₂₁ and 409₂₂, the RSs of the set of RSs are measured by the UE 110 and/or TRP 120₁, as well as neighbouring TRPs 120ₙ and/or UEs 110ₙ.

As is shown with respect to message 413, the UE 110 (or, in other examples [not shown], the TRP 120₁, as well as other TRPs 120ₙ and/or UEs 110ₙ) reports its measurement results of the RSs of set of RSs to the LS 140. As will be discussed below, in some examples, instead of awaiting transmission for all of the RS of the set of RSs before reporting the measurement results, intermediary reporting of measurement results can be effected wherein measurement results of individual one(s) of the RSs of the set of RSs are reported to the LS prior to completion of the reception of all of the RSs of the set of RSs, such reporting is effected via the transmission of an Intermediate Position Report (IPR). In some examples, the UE and/or the TRPs may measure the RSs which are received and/or transmitted during a predetermined measurement period (or measurement time window) and report the measurement report(s) to the LS 140.

In block 500, the LS determines a position of the UE based on the received measurement results. In some examples, i.e., where a UE-based positioning solutions is implemented (rather than a UE-assisted positioning solution as per FIG. 3), the measurement results of the TRPs and other UEs are send to the UE, following which the UE determines its position.

FIG. 4 is a signalling diagram illustrating signaling—between an LS 140, a UE 110, a serving TRP 120₁ and one or more neighbouring TRPs 120ₙ—for providing a hierarchical positioning session (i.e., a hierarchical LPP session) that merges NR spectra and NR-U spectra positioning RSs': transmission, reception, processing and reporting. The hierarchical positioning session can provide a unified framework which allows a LS to recover an accuracy of an otherwise poor-quality positioning session.

In block 401—namely 401₁₁, 401₁₂ and 401₂—capability reporting is performed. In particular, in block 401₁₁ and 401₁₂, a serving TRP 120₁ and a neighbouring TRP 120ₙ report their capability for transmission, reception, and processing of signals in each of NR and NR-U spectra. In this regard, the TRPs can report their relevant Radio Frequency, RF, and BaseBand, BB, capabilities to an LS 140 (e.g., RF front end and BB analog front-end and digital back-end). Similarly, in block 401₂, a UE 110 reports its capability for transmission, reception, and processing of signals in each of NR and NR-U spectra. In this regard, the UE can report its relevant RF and BB capabilities to the LS 140. In this regard, the LS obtains the relevant RF and BB capabilities of the devices involved in a positioning session (i.e., the [target] UE and TRPs via LPP and NRPPa respectively). These capabilities may refer to at least whether the device (e.g., UE 110, TRP 120₁, and/or TRP 120ₙ) supports NR and/or NR-U transmission and/or reception, as well as the operating frequencies in both NR and NR-U spectrum. The capability information may refer to which carriers and bandwidths the device can transmit and receive on. When available, the devices can also inform the LS of the device's latency figures involved in the process of switching transceiver chains from one frequency to another. Such device frequency switching latency information may be signalled in the same capability report or separately.

In block 402, the service TRP informs the LS of Quality of Service, QoS, requirements for the positioning of the [target] UE, such as the latency, accuracy and integrity required for the positioning session. The integrity is a measure of trust that can be placed in the correctness of information supplied by a navigation system. The integrity includes the ability of a system to provide timely warnings to user receivers in case of failure.

In block 403, the neighbouring TRPs inform the LS of spectrum utilization information including: spectrum availability/load, traffic/cell load, power spectral density, channel conditions available at the TRPs. The serving TRP may likewise also send such spectrum utilization information.

In block 404, the LS uses the received: capability, QoS and spectrum utilization information along with internal Radio Resource Management, RRM, functionality to identify available spectrum portions, of each of NR and NR-U, and select which spectrum portions are to be involved in positioning the target UE. For instance, such information may be used by the LS to decide which spectrum portions can be used for RSs of the set of RSs and the order/prioritization of RSs of the set of RSs. Implementation of LS RRM for positioning can be an extension of the available NR RRM performed by the serving TRP (i.e., the serving gNB). To enable it, however, the LS may need to collect various Key Performance Indicators, KPIs. Such KPI's may include: traffic load and patterns as well as channel conditions from all the required TRPs (which can be provided over an NRPPa interface); and the positioning QoS requirements for the target UE (e.g., latency, accuracy, integrity, etc.).

In block 405, the LS selects a set of NR spectrum portions and a set of NR-U spectrum portions for a positioning session for a target UE. the LS configures the positioning RSs' (i.e., PRS for DL or SRS for UL) transmission scheme for both NR and NR-U spectra. Such a transmission scheme is referred to herein as a joint Hierarchical Positioning Protocol, HPP, or a joint hierarchical positioning session.

The LS's configuration of the positioning RSs comprises, not least, configuring:
a) a time-frequency-space-code pattern for NR spectra positioning RS(s).
b) a time-frequency-space-code pattern for NR-U spectra positioning RS(s).
An LBT protocol to be applied with regards to NR-U transmissions can also be configured.
c) a set of TRPs to implement a) and b). The LS may select the same or different TRP sets to perform both NR and NR-U spectra operations.
For example, the LS may prefer to select:
   i. TRP 1,2, . . . , N for NR RSs of the set of RSs; and TRPs N+1, . . . , N+P for NR-U RSs of the set of RSs; or
   ii. TRP 1, . . . , N for both NR and NR-U RSs of the set of RSs; or
   iii. N TRPs for NR RSs of the set of RSs and P<<N TRPs (same or different) for NR-U RSs of the set of RSs. In this case, the P TRPs may be configured with a large bandwidth, to ensure resolution gain with a few NR-U RSs transmissions of the set of RSs.
d) an order, repetition and periodicity pattern that indicates how a) and b) are to be performed—thereby defining a set of RSs comprising an ordered sequence of one or more NR RSs and one or more NR-U RSs, as well as scheduling the transmission and reception/measurement (and reporting) of the same. Here, dedicated slots may additionally be configured, i.e., in and amongst the set of RSs. During these slots, the positioning receivers and transmitters may receive additional instructions from the LS (e.g., to terminate the positioning session early, i.e., to cease transmitting/receiving/measuring and/or reporting any further RSs), or the slots may be configured for the positioning receiver to send Intermediate Positioning Reports, IPRs, (wherein IPRs are reports of measurements of received individual one(s) of the RSs of the set of RSs that are sent to the LS prior to the receiver completing its reception of all of the RSs of the set of RSs that the receiver has been configured to receive. I.e., instead of waiting to receive all of the RS of the set of RSs before reporting the measurement results, one or more IPRs, reporting intermediary measurement results of individual one(s) of the RSs of the set of RSs, is sent by the receiver to the LS). By way of an example, the LS may schedule a transmission pattern:
   HPP_TX=[NR RS, t1, NR-U RS, t2, NR-U RS, t1, . . . ]
   where t1 and t2 are dedicated time slots of different durations, during which the UE and/or TRP are expected to receive/listen for an indication from LS on whether to continue the transmission or terminate it.
   More specifically, a transmitter, implementing such a received example transmission scheme/pattern, would perform the following sequence of operations: it performs an NR RS transmission during a first time interval;
   subsequently it stays quiet/silent (i.e., it does not transmit) for a duration t1;
   after which it sends an NR-U RS; followed by a further quiet/silent time period of duration t2; then another NR-U transmission follows; and another quiet interval of duration t1 is scheduled . . . .
Similarly, the LS may schedule a measurement collection pattern:
   HPP_RX=[p_NR RS, t1_IPR, p_NR-U RS, t2_IPR, p_NR-U RS, t1_listen, . . . ]
   where p_NR RS and p_NR-U RS are the measurements the receiver should collect for NR and respectively NR-U positioning signals. For example, p_NR RS={TOA, AOA}; p_NR-U RS={TOA}; wherein p_NR RS={TOA, AOA} signifies that the receiver should measure and report both TOA and AOA on the detected NR RS, and wherein p_NR-U RS={TOA} signifies that the receiver is configured to measure TOA on the NR-U RS.
   A receiver, implementing such a received example reception scheme/pattern, would perform the following operations: it measures NR RS during the first time interval; then, during t1, it sends an IPR for the NR RS measurement; following which it measures NR-U RS; and then, during t2, it sends an IPR report of the NR-U measurement; this is followed by another NR-U positioning signal measurement; followed by listening interval of duration t1 in which the receiver may receive further instructions . . . .
The dedicated slots t1 and t2 may be used for receiving instructions from the LS, or for sending IPRs. Men they are used for listening for instructions, they are denoted as “_listen” and when used for sending IPR, are denoted as “_IPR”.
The LS may define the length and the frequency and density of each a) and b) depending on the QoS positioning requirements for the target UE. For example, if the UE is latency sensitive, the LS may implement a fast-positioning session, with a few cycles between NR RS and NR-U RS, and/or with no/very short listening intervals t1, t2: HPP_TX=[NR RS, NR-U RS, NR RS]. Similarly, it may prefer more NR RSs and introduce a final NR-U RS for resolution enhancement HPP_TX=[NR RS, NR RS, NR-U RS].
For the NR-U positioning RS, the LS may select a set of parameters per TRP defined as a list of {sequencetype, carrier_frequency, time_offset, bandwidth, frequency_offset, repetition_pattern, period, comb}, where:
   Sequence_type can be, for example: “Zadoff-Chu” or “Gold sequence” with specified ID (where ID can be a set of parameters needed to generate the sequence, e.g., for Zadoff-Chu, ID={root R, length L}).
   Carrier_frequency defines the carrier, e.g., in MHz for the transmission.
   Time_offset defines a number of OFDM symbols relative to a subframe start.
   Bandwidth and frequency_offset define a number of subcarriers and the subcarrier index respectively.
   Repetition_pattern defines a number of consecutive OFDM symbols used for the TX
   Period defines a number of subframes after which the transmission is repeated.
   Comb defines a number of gap subcarriers.

In block 406, the LS send configuration information to the UE and TRPs. In the example shown, the LS sends, via message 406₁₁ and 406₁₂ configuration information to the TRPs 120₁ and 120ₙ to configure the TRPs for the transmission of the set of RSs. Such transmission configuration information for the HPP session is shown in FIG. 4 as HPP_TX. The LS sends, via message 406₂, configuration information to the UE 110 to configure the UE for the reception of the set of RSs. Such reception configuration information for the HPP session is shown in the Figure as HPP_RX. The configuration information may schedule the transmission (and reception) of one or more NR RS in the set of RSs so as to be interleaved with the scheduling of the transmission (and reception) one or more NR-U RSs of the set of RSs. The message 406₂ may be directly transmitted to the UE from the LS 140, or transmitted via the serving TRP 120₁.

The LS can thereby preconfigure the devices selected to be involved in the HPP session via an enhanced assistance data message carried by:
LPP signaling to the target UE, and
NRPPa signaling to the TRPs. This configuration may need a two-way handshake with the TRPs, in which they accept or reject the assigned HPP.

In block 407, when it is subsequently desired to determine the position of the UE, the LS can trigger the (pre-configured) HPP session by requesting a set of positioning measurements, e.g., via messages 408₁₁, 408₁₂ and 408₂ to the: serving TRP, neighbouring TRPs and UE respectively. When receiving the request, such entities involved in the hybrid positioning session know to perform the transmission and respectively reception having been previously configured with HPP_TX and HPP_RX.

For DL positioning (as shown in FIG. 4), in blocks 409₁₁ and 409₁₂, the TRPs transmits RS (e.g., and ordered sequence of NR RSs and NR-U RSs of the set of RSs) as instructed in HPP_TX. In block 409₂, the UE receives and measures positioning signals as instructed in HPP_RX. It is to be appreciated that for UL positioning, the TRP does the same operation, on UL positioning signals transmitted by the UE.

During pre-configured dedicated slots, the UEs and/or TRPs are expected to receive, i.e., listen out for, an indication from the LS on whether to continue the transmission (or reception and measurement) of the set of RSs or terminate it. In this regard, the transmitter (e.g., UE in UL, and TRP in DL) waits for a trigger/flag to continue or terminate early the set of RSs. The receiver (TRP in UL, and UE in DL) waits for a trigger/flag to continue or terminate early the signal reception and measurement.

During the dedicated silent slots, e.g., t1/2:
a. the LS may send, e.g., in block 410 via messages 411₁ and 411₂, a flag to instruct the transmitter(s) (TRP in DL [as shown], and UE in UL) to terminate or continue the session. The transmitter waits for a trigger/flag during the dedicated silent slots. This flag is sent to the UE over an NR PDCCH in case of UL positioning, and over NRPPa to the TRP in case of DL positioning. This flag can be defined as: “HPP_ET=1 if early termination and 0 otherwise”.
b. the receiver (UE in DL [as shown], and TRP in UL) checks the type of silent interval:
   i. if the subsequent silent interval is a reporting interval, e.g., as per block 412, namely t1_IPR and/or t2_IPR, then the receiver sends an IPR 413 over an NR control channel, and the LS uses this report to compute an intermediate location estimate, as per block 416. The report is either an IPR of NR RSs or NR-U RSs and it is denoted either NR-IPR or NR-U-IPR.
   ii. If the subsequent silent interval is a listening interval, e.g., as per block 415, namely t1_listen and/or t2_listen, then the receiver switches to listening for further instructions sent over an NR control channel. Here, the LS may signal whether the HPP is being terminated early, e.g., via message/flag 414. An HPP early termination may occur if an intermediate position estimation (i.e., following receipt of one or more IPRs and position estimation using the same) is deemed to be sufficiently accurate. The early termination can be signalled via an HPP_ET flag.

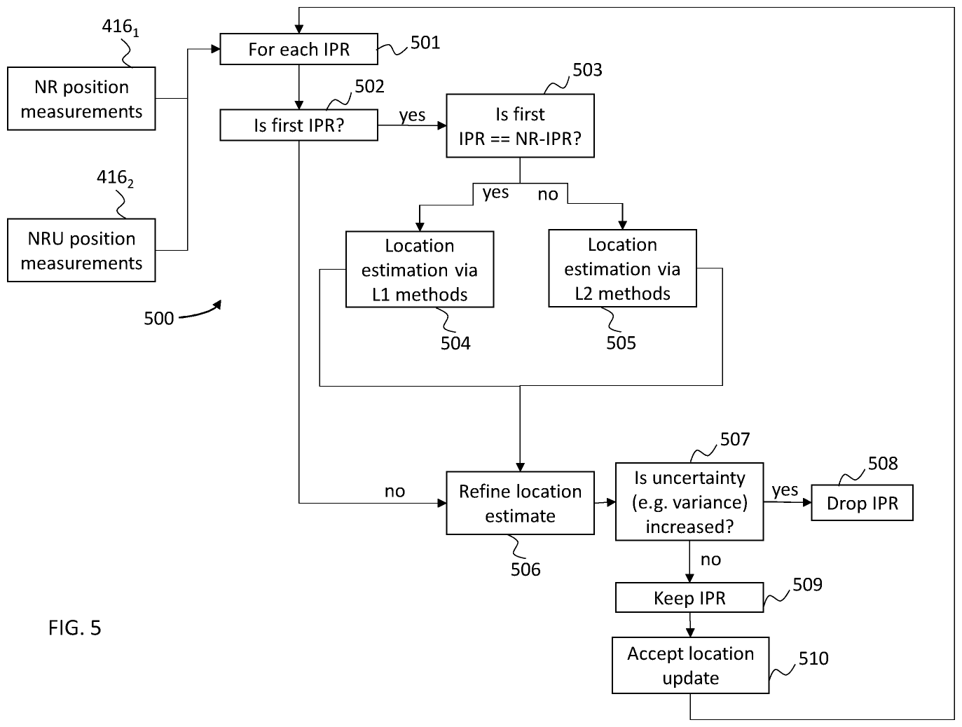

In block 416, the LS collects measurements of the transmitted and received NR and NR-U RSs in the sequential manner of the set of RSs as defined by the HPP_TX and HPP_RX. The LS then computes the UE location via a hierarchical approach, as discussed in further detail below with respect to FIG. 5.

Whilst FIG. 4 shows DL positioning, it is to be appreciated that the procedure and signalling can be duly re-configured, mutatis mutandis, for UL positioning. For instance, the TRPs can be configured to receive and detect a set of RSs transmitted by a UE that itself has been duly configured to transmit the set of RSs.

FIG. 5 is a schematic diagram of a method 500 for computing a location of a UE via a hierarchical approach that may be performed by an LS 140.

The LS receives an ordered sequence of measurements of transmitted NR and NR-U RSs, i.e., as defined by the HPP_TX and HPP_RX configuration information discussed above via which the LS configures devices selected to be involved in the HPP session with an ordered sequence of a set of NR and NR-U RSs (wherein the NR RS's may be interleaved with the NR-U RSs of the set of RSs of the HPP session) for transmission or reception. The received measurements may be one or more Intermediate Positioning Reports, IPRs, of one or more received NR RSs and/or NR-U RSs of the set of RSs, received during one or more slots that have been dedicated/configured for the receiver to transmit intermediate measurements of RSs received thus far, i.e., prior to completion of the transmission/reception of the whole set of RSs. In particular, the LS uses each IPR sequentially as follows.

Block 4161, shows the receipt by the LS of an NR RS IPR measurement, whereas block 416₂, shows the receipt by the LS of an NR-U RS IPR measurement.

As indicated in block 501, for each received IPR, a determination is made in block 502 whether the received IPR is the first IPR that has been received in the HPP session.

If, as per the ‘yes’ branch from block 503, the first IPR is a measurement result for an NR RS (referred to as an ‘NR-IPR’), the LS may trigger a first localization method (referred to as ‘L1’) and compute an initial position estimate using the NR-IPR and L1, as per block 504. Examples of L1 may be, for example: classical multi-lateration using least square methods, Kalman filtering, or fingerprinting based methods.

If, as per the ‘no’ branch from block 503, the first IPR is not a NR-IPR, i.e., instead the measurement result is for an NR-U RS (referred to as an ‘NRU-IPR’), the LS may trigger a second localization method (referred to as ‘L2’) and compute an initial position estimate using the NRU-IPR and L2, as per block 505.

In block 506, for subsequently received IPRs, i.e., the ‘non-first IPRs’ the following the first IPR, the LS uses the current position estimate (i.e., the initial position estimate from block 504 or 505) and the most recent IPR to refine the estimation.

In this regard, in block 507, the LS may test each current/further received IPR and recompute a position estimate and its uncertainty, e.g., position variance. Accordingly, for each positioning measurement in a current IPR:
i. if adding the measurement to the estimation leads to a variance increase (i.e., increases uncertainty), then the measurement is dropped, as per block 508.
ii. if by adding the measurement, the variance decreases, the measurement is retained, as per block 509, and the position estimate is updated, as per block 510.

Examples of the present disclosure may provide one of more of the following advantage:
improved/higher measurement resolution due to being able to access larger bandwidths in the NR-U spectrum;
improved/higher positioning accuracy since measurements can be collected from two different spectra portions, i.e., NR and NR-U, which may not exhibit/suffer from the same levels of interference; and
lower latency since the number of measurement gap reconfigurations may be reduced. For instance, the UE does not need to switch between many differing NR carriers to access small bandwidths on each, but instead may access an NR-U carrier with (single) large bandwidth in one go.

The blocks and signalling illustrated in FIGS. 2-5 and discussed above can represent actions in a method, functionality performed by an apparatus, and/or sections of instructions/code in a computer program.

It will be understood that each block and at least part of the combinations of blocks illustrated in FIGS. 2-5, as well as the further functions described above, can be implemented by various means, such as hardware, firmware, and/or software including one or more computer program instructions. For example, at least part of one or more of the functions described can be performed by a duly configured apparatus (such as: a UE 110 or TPT/gNB 120, or LMF 140), comprising means for performing the described functions. Furthermore, at least part of the one or more of the functions described can be embodied by a duly configured computer program (such as a computer program comprising computer program instructions which embody the functions described below and which can be stored by a memory storage device and performed by a processor).

As will be appreciated, any such computer program instructions can be loaded onto a computer or other programmable apparatus (i.e., hardware) to produce a machine, such that the instructions when performed on the programmable apparatus create means for implementing the functions specified in the blocks. These computer program instructions can also be stored in a computer-readable medium that can direct a programmable apparatus to function in a particular manner, such that the instructions stored in the computer-readable memory produce an article of manufacture including instruction means which implement the function specified in the blocks. The computer program instructions can also be loaded onto a programmable apparatus to cause a series of operational actions to be performed on the programmable apparatus to produce a computer-implemented process such that the instructions which are performed on the programmable apparatus provide actions for implementing the functions specified in the blocks.

Various, but not necessarily all, examples of the present disclosure can take the form of a method, an apparatus or a computer program. Accordingly, various, but not necessarily all, examples can be implemented in hardware, software or a combination of hardware and software.

Various, but not necessarily all, examples of the present disclosure are described using flowchart illustrations and schematic block diagrams. It will be understood that each block (of the flowchart illustrations and block diagrams), and combinations of blocks, can be implemented by computer program instructions of a computer program. These program instructions can be provided to one or more processor(s), processing circuitry or controller(s) such that the instructions which execute on the same create means for causing implementing the functions specified in the block or blocks, i.e., such that the method can be computer implemented. The computer program instructions can be executed by the processor(s) to cause a series of operational steps/actions to be performed by the processor(s) to produce a computer implemented process such that the instructions which execute on the processor(s) provide steps for implementing the functions specified in the block or blocks.

Accordingly, the blocks support combinations of means for performing the specified functions; combinations of actions for performing the specified functions; and computer program instructions/algorithm for performing the specified functions. It will also be understood that each block, and at least part of the combinations of blocks, can be implemented by special purpose hardware-based systems which perform the specified functions or actions, or combinations of special purpose hardware and computer program instructions.

Various, but not necessarily all, examples of the present disclosure provide both a method and corresponding apparatus comprising various modules, means or circuitry that provide the functionality for performing/applying the actions of the method. The modules, means or circuitry can be implemented as hardware, or can be implemented as software or firmware to be performed by a computer processor. In the case of firmware or software, examples of the present disclosure can be provided as a computer program product including a computer readable storage structure embodying computer program instructions (i.e., the software or firmware) thereon for performing by the computer processor.

FIG. 6 schematically illustrates a block diagram of an apparatus 10 for performing the methods, processes, procedures and signaling described in the present disclosure and illustrated in FIGS. 2-5. In this regard, in some examples the apparatus can perform the role of a UE 110, in other examples it can perform the role of a TRP 120, and in yet other examples it can perform the role of a LS 140 with regards to the illustrated and described methods and signalling diagrams. The component blocks of FIG. 6 are functional and the functions described can be performed by a single physical entity.

The apparatus 10 comprises a controller 11, which could be provided within a device such as a UE 110, a TRP 120 or an LMF 140.

The controller 11 can be embodied by a computing device, not least such as those mentioned above. In some, but not necessarily all examples, the apparatus can be embodied as a chip, chip set or module, i.e., for use in any of the foregoing. As used here ‘module’ refers to a unit or apparatus that excludes certain parts/components that would be added by an end manufacturer or a user.

Implementation of the controller 11 can be as controller circuitry. The controller 11 can be implemented in hardware alone, have certain aspects in software including firmware alone or can be a combination of hardware and software (including firmware).

The controller 11 can be implemented using instructions that enable hardware functionality, for example, by using executable instructions of a computer program 14 in a general-purpose or special-purpose processor 12 that can be stored on a computer readable storage medium 13, for example memory, or disk etc, to be executed by such a processor 12.

The processor 12 is configured to read from and write to the memory 13. The processor 12 can also comprise an output interface via which data and/or commands are output by the processor 12 and an input interface via which data and/or commands are input to the processor 12. The apparatus can be coupled to or comprise one or more other components 15 (not least for example: a radio transceiver, sensors, input/output user interface elements and/or other modules/devices/components for inputting and outputting data/commands).

The memory 13 stores a computer program 14 comprising computer program instructions (computer program code) that controls the operation of the apparatus 10 when loaded into the processor 12. The computer program instructions, of the computer program 14, provide the logic and routines that enables the apparatus to perform the methods, processes and procedures described in the present disclosure and illustrated in FIGS. 2-5. The processor 12 by reading the memory 13 is able to load and execute the computer program 14.

Although the memory 13 is illustrated as a single component/circuitry it can be implemented as one or more separate components/circuitry some or all of which can be integrated/removable and/or can provide permanent/semi-permanent/dynamic/cached storage.

Although the processor 12 is illustrated as a single component/circuitry it can be implemented as one or more separate components/circuitry some or all of which can be integrated/removable. The processor 12 can be a single core or multi-core processor.

The apparatus can include one or more components for effecting the methods, processes and procedures described in the present disclosure and illustrated in FIGS. 2-5. It is contemplated that the functions of these components can be combined in one or more components or performed by other components of equivalent functionality. The description of a function should additionally be considered to also disclose any means suitable for performing that function. Where a structural feature has been described, it can be replaced by means for performing one or more of the functions of the structural feature whether that function or those functions are explicitly or implicitly described.

Although examples of the apparatus have been described above in terms of comprising various components, it should be understood that the components can be embodied as or otherwise controlled by a corresponding controller or circuitry such as one or more processing elements or processors of the apparatus. In this regard, each of the components described above can be one or more of any device, means or circuitry embodied in hardware, software or a combination of hardware and software that is configured to perform the corresponding functions of the respective components as described above.

The apparatus can, for example, be a client device, a server device, a mobile cellular telephone, a base station in a mobile cellular telecommunication system, a wireless communications device, a hand-portable electronic device, a location/position tag, a hyper tag etc. The apparatus can be embodied by a computing device, not least such as those mentioned above. However, in some examples, the apparatus can be embodied as a chip, chip set or module, i.e., for use in any of the foregoing.

In one example, the apparatus is embodied on a hand held portable electronic device, such as a mobile telephone, wearable computing device or personal digital assistant, that can additionally provide one or more audio/text/video communication functions (for example tele-communication, video-communication, and/or text transmission (Short Message Service (SMS)/Multimedia Message Service (MMS)/emailing) functions), interactive/non-interactive viewing functions (for example web-browsing, navigation, TV/program viewing functions), music recording/playing functions (for example Moving Picture Experts Group-1 Audio Layer 3 (MP3) or other format and/or (frequency modulation/amplitude modulation) radio broadcast recording/playing), downloading/sending of data functions, image capture function (for example using a (for example in-built) digital camera), and gaming functions.

In examples, e.g., where the apparatus is provided within a UE 110 or a TRP 120, the apparatus comprises:
at least one processor 12; and
at least one memory 13 including computer program code
the at least one memory 13 and the computer program code configured to, with the at least one processor 12, cause the apparatus at least to perform:
   receiving configuration information, wherein the configuration information comprises information for configuring a transmission or a reception, by the apparatus to or from at least one node a Radio Access Network, RAN, of a set of Reference Signals, RSs; wherein the set of RSs comprises:
      at least a first RS to be transmitted or received within a first frequency range, and
      at least a second RS to be transmitted or received within a second frequency range; and
   based at least in part on the configuration information, causing the transmission or the reception of the set of RSs to or from the at least one node of the RAN.

In examples where the apparatus is provided within an LMF 140, the apparatus comprises:
at least one processor 12; and
at least one memory 13 including computer program code
the at least one memory 13 and the computer program code configured to, with the
at least one processor 12, cause the apparatus at least to perform:
determining configuration information, wherein the configuration information comprises information for configuring a transmission or a reception, by an apparatus to or from at least one node a Radio Access Network, RAN, of a set of Reference Signals, RSs; wherein the set of RSs comprises:
at least a first RS to be transmitted or received within a first frequency range, and
at least a second RS to be transmitted or received within a second frequency range. causing transmission of the configuration information to the apparatus.

According to some examples of the present disclosure, there is provided a system comprising at least one UE 110, at least one TRP 120 and at least one LS 140 as described above.

The above described examples find application as enabling components of tracking systems, automotive systems; telecommunication systems; electronic systems including consumer electronic products; distributed computing systems; media systems for generating or rendering media content including audio, visual and audio visual content and mixed, mediated, virtual and/or augmented reality; personal systems including personal health systems or personal fitness systems; navigation systems; user interfaces also known as human machine interfaces; networks including cellular, non-cellular, and optical networks; ad-hoc networks; the internet; the internet of things (IoT); Vehicle-to-everything (V2X), virtualized networks; and related software and services.

The apparatus can be provided in an electronic device, for example, a mobile terminal, according to an example of the present disclosure. It should be understood, however, that a mobile terminal is merely illustrative of an electronic device that would benefit from examples of implementations of the present disclosure and, therefore, should not be taken to limit the scope of the present disclosure to the same. While in certain implementation examples, the apparatus can be provided in a mobile terminal, other types of electronic devices, such as, but not limited to, hand portable electronic devices, wearable computing devices, portable digital assistants (PDAs), pagers, mobile computers, desktop computers, televisions, gaming devices, laptop computers, cameras, video recorders, GPS devices and other types of electronic systems, can readily employ examples of the present disclosure. Furthermore, devices can readily employ examples of the present disclosure regardless of their intent to provide mobility.

FIG. 7, illustrates a computer program 14 conveyed via a delivery mechanism 20. The delivery mechanism 20 can be any suitable delivery mechanism, for example, a machine-readable medium, a computer-readable medium, a non-transitory computer-readable storage medium, a computer program product, a memory device, a solid-state memory, a record medium such as a Compact Disc Read-Only Memory (CD-ROM) or a Digital Versatile Disc (DVD) or an article of manufacture that comprises or tangibly embodies the computer program 14. The delivery mechanism can be a signal configured to reliably transfer the computer program. An apparatus can receive, propagate or transmit the computer program as a computer data signal.

In certain examples of the present disclosure, there is provided computer program instructions for causing an apparatus (e.g., a UE 110 or a TRP 120) to perform at least the following or for causing performing at least the following: RECTIFIED SHEET (RULE 91) ISA/EP receiving configuration information, wherein the configuration information comprises information for configuring a transmission or a reception, by the apparatus to or from at least one node a Radio Access Network, RAN, of a set of Reference Signals, RSs; wherein the set of RSs comprises:
at least a first RS to be transmitted or received within a first frequency range, and
at least a second RS to be transmitted or received within a second frequency range; and
based at least in part on the configuration information, causing the transmission or the reception of the set of RSs to or from the at least one node of the RAN.

In certain examples of the present disclosure, there is provided computer program instructions for causing an apparatus (e.g., an LS 140) to perform at least the following or for causing performing at least the following:
determining configuration information, wherein the configuration information comprises information for configuring a transmission or a reception, by an apparatus to or from at least one node a Radio Access Network, RAN, of a set of Reference Signals, RSs; wherein the set of RSs comprises:
   at least a first RS to be transmitted or received within a first frequency range, and
   at least a second RS to be transmitted or received within a second frequency range. causing transmission of the configuration information to the apparatus.

References to ‘computer program’, ‘computer-readable storage medium’, ‘computer program product’, ‘tangibly embodied computer program’ etc. or a ‘controller’, ‘computer’, ‘processor’ etc. should be understood to encompass not only computers having different architectures such as single/multi-processor architectures and sequential (Von Neumann)/parallel architectures but also specialized circuits such as field-programmable gate arrays (FPGA), application specific circuits (ASIC), signal processing devices and other devices. References to computer program, instructions, code etc. should be understood to encompass software for a programmable processor or firmware such as, for example, the programmable content of a hardware device whether instructions for a processor, or configuration settings for a fixed-function device, gate array or programmable logic device etc.

As used in this application, the term ‘circuitry’ can refer to one or more or all of the following:
(a) hardware-only circuitry implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions and
(c) hardware circuit(s) and/or processor(s), such as a microprocessor(s) or a portion of a microprocessor(s), that requires software (for example firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor and its (or their) accompanying software and/or firmware. The term circuitry also covers, for example and if applicable to the particular claim element, a baseband integrated circuit for a mobile device or a similar integrated circuit in a server, a cellular network device, or other computing or network device.

Although specific terms are employed herein, they are used in a generic and descriptive sense only and not for purposes of limitation. Features described in the preceding description can be used in combinations other than the combinations explicitly described. Although functions have been described with reference to certain features, those functions can be performable by other features whether described or not. Although features have been described with reference to certain examples, those features can also be present in other examples whether described or not. Accordingly, features described in relation to one example/aspect of the disclosure can include any or all of the features described in relation to another example/aspect of the disclosure, and vice versa, to the extent that they are not mutually inconsistent.

Although various examples of the present disclosure have been described in the preceding paragraphs, it should be appreciated that modifications to the examples given can be made without departing from the scope of the invention as set out in the claims. For example, whilst the figures illustrate procedures and signalling for DL positioning, it is to be appreciated that examples of the present disclosure also extend to procedures and signalling for UL positioning.

The term ‘comprise’ is used in this document with an inclusive not an exclusive meaning. That is any reference to X comprising Y indicates that X can comprise only one Y or can comprise more than one Y. If it is intended to use ‘comprise’ with an exclusive meaning then it will be made clear in the context by referring to “comprising only one . . . ” or by using “consisting”.

As used herein, the term “determine/determining” (and grammatical variants thereof) can include, not least calculating, computing, processing, deriving, measuring, investigating, identifying, looking up (for example, looking up in a table, a database or another data structure), ascertaining and the like. Also, “determining” can include receiving (for example, receiving information), accessing (for example, accessing data in a memory), obtaining and the like. Also, “determine/determining” can include resolving, selecting, choosing, establishing, and the like.

References to a parameter (not least for example measurement results) can be replaced by references to “data indicative of”, “data defining” or “data representative of” the relevant parameter if not explicitly stated.

In this description, reference has been made to various examples. The description of features or functions in relation to an example indicates that those features or functions are present in that example. The use of the term ‘example’ or ‘for example’, ‘can’ or ‘may’ in the text denotes, whether explicitly stated or not, that such features or functions are present in at least the described example, whether described as an example or not, and that they can be, but are not necessarily, present in some or all other examples. Thus ‘example’, ‘for example’, ‘can’ or ‘may’ refers to a particular instance in a class of examples. A property of the instance can be a property of only that instance or a property of the class or a property of a sub-class of the class that includes some but not all of the instances in the class.

In this description, references to “a/an/the” [feature, element, component, means . . . ] are to be interpreted as “at least one” [feature, element, component, means . . . ] unless explicitly stated otherwise. That is any reference to X comprising a/the Y indicates that X can comprise only one Y or can comprise more than one Y unless the context clearly indicates the contrary. If it is intended to use ‘a’ or ‘the’ with an exclusive meaning then it will be made clear in the context. In some circumstances the use of ‘at least one’ or ‘one or more’ can be used to emphasise an inclusive meaning but the absence of these terms should not be taken to infer any exclusive meaning.

The presence of a feature (or combination of features) in a claim is a reference to that feature (or combination of features) itself and also to features that achieve substantially the same technical effect (equivalent features). The equivalent features include, for example, features that are variants and achieve substantially the same result in substantially the same way. The equivalent features include, for example, features that perform substantially the same function, in substantially the same way to achieve substantially the same result.

In this description, reference has been made to various examples using adjectives or adjectival phrases to describe characteristics of the examples. Such a description of a characteristic in relation to an example indicates that the characteristic is present in some examples exactly as described and is present in other examples substantially as described.

In the above description, the apparatus described can alternatively or in addition comprise an apparatus which in some other examples comprises a distributed system of apparatus, for example, a client/server apparatus system. In examples where an apparatus provided forms (or a method is implemented as) a distributed system, each apparatus forming a component and/or part of the system provides (or implements) one or more features which collectively implement an example of the present disclosure. In some examples, an apparatus is re-configured by an entity other than its initial manufacturer to implement an example of the present disclosure by being provided with additional software, for example by a user downloading such software, which when executed causes the apparatus to implement an example of the present disclosure (such implementation being either entirely by the apparatus or as part of a system of apparatus as mentioned hereinabove).

The above description describes some examples of the present disclosure however those of ordinary skill in the art will be aware of possible alternative structures and method features which offer equivalent functionality to the specific examples of such structures and features described herein above and which for the sake of brevity and clarity have been omitted from the above description. Nonetheless, the above description should be read as implicitly including reference to such alternative structures and method features which provide equivalent functionality unless such alternative structures or method features are explicitly excluded in the above description of the examples of the present disclosure.

Whilst endeavouring in the foregoing specification to draw attention to those features of examples of the present disclosure believed to be of particular importance it should be understood that the applicant claims protection in respect of any patentable feature or combination of features hereinbefore referred to and/or shown in the drawings whether or not particular emphasis has been placed thereon.

The examples of the present disclosure and the accompanying claims can be suitably combined in any manner apparent to one of ordinary skill in the art. Separate references to an “example”, “in some examples” and/or the like in the description do not necessarily refer to the same example and are also not mutually exclusive unless so stated and/or except as will be readily apparent to those skilled in the art from the description. For instance, a feature, structure, process, step, action, or the like described in one example may also be included in other examples, but is not necessarily included.

Each and every claim is incorporated as further disclosure into the specification and the claims are embodiment(s) of the present disclosure. Further, while the claims herein are provided as comprising specific dependencies, it is contemplated that any claims can depend from any other claims and that to the extent that any alternative embodiments can result from combining, integrating, and/or omitting features of the various claims and/or changing dependencies of claims, any such alternative embodiments and their equivalents are also within the scope of the disclosure.

1-33. (canceled)

34. An apparatus comprising:
at least one processor, and
at least one memory including computer program instructions;
the at least one memory and the computer program instructions configured to, with the at least one processor, cause the apparatus at least to perform:
receiving configuration information, wherein the configuration information comprises information for configuring a transmission or a reception, by the apparatus to or from at least one node a Radio Access Network, RAN, of a set of Reference Signals, RSs; wherein the set of RSs comprises:
at least a first RS to be transmitted or received within a first frequency range, and
at least a second RS to be transmitted or received within a second frequency range; and
based at least in part on the configuration information, causing the transmission or the reception of the set of RSs to or from the at least one node of the RAN.

35. The apparatus of claim 34, wherein the at least first RS and/or the at least second RS is at least one selected from a group of:
an RS configured for use in determining a position of a User Equipment, UE, of the RAN;
a downlink, DL, RS;
a Positioning Reference Signal, PRS;
an uplink, UL, RS; and
a Sounding Reference Signal, SRS.

36. The apparatus of claim 34, wherein the first frequency range is within at least one selected from a group of:
a frequency range or band licensed for use by the RAN;
a frequency range or band of a New Radio, NR, spectrum;
a frequency range or band licensed for 5th Generation, 5G, NR;
a frequency range or band where access to the frequency range or band is planned and/or cannot be accessed opportunistically; and
a frequency range or band where a performance of a Listen Before Talk, LBT, procedure is not required for a transmission therein.

37. The apparatus of claim 34, wherein the second frequency range is within at least one selected from a group of:
a frequency range or band unlicensed for use by the RAN;
a frequency range or band of a New Radio Unlicensed, NR-U, spectrum;
a frequency range or band not licensed for 5th Generation, 5G, NR;
a frequency range or band where access to the frequency range or band is unplanned and/or is accessed opportunistically; and
a frequency range or band where a performance of a Listen Before Talk, LBT, protocol is required for a transmission therein.

38. The apparatus of claim 34, wherein the configuration information comprises an indication of first information for enabling the apparatus to determine at least one selected from a group of:
resources for the at least one first RS and the at least one second RS of the set of RSs;
a time, a frequency, a space, and/or a code for use with the at least one first RS and the at least one second RS of the set of RSs;
a pattern, a sequence, an order and/or an interleaving of the at least one first RS and the at least one second RS of the set of RSs;
a Listen Before Talk, LBT, protocol to implement for the transmission of the at least one second RS of the set of RSs;
a number of repetitions of the transmission or reception of the set of RSs; and
a periodicity of repetitions of the transmission or reception of the set of RSs.

39. The apparatus of claim 34, wherein the configuration information comprises an indication of second information for enabling the apparatus to determine at least one selected from a group of the following parameters to be use for the transmission or reception of the at least first and/or second RS:
a sequence type;
a carrier frequency;
a time offset;
a bandwidth;
a frequency offset;
a repetition pattern;
a period; and
a comb.

40. The apparatus of claim 34, further comprising means for, responsive to receipt of a trigger, causing the transmission or the reception of the set of RSs to or from the at least one node of the RAN in accordance with the configuration information.

41. A method comprising causing, at least in part, actions that result in:
receiving configuration information, wherein the configuration information comprises information for configuring a transmission or a reception, by the apparatus to or from at least one node a Radio Access Network, RAN, of a set of Reference Signals, RSs; wherein the set of RSs comprises:
at least a first RS to be transmitted or received within a first frequency range, and
at least a second RS to be transmitted or received within a second frequency range; and
based at least in part on the configuration information, causing the transmission or the reception of the set of RSs to or from the at least one node of the RAN.

42. The method of claim 41, wherein the at least first RS and/or the at least second RS is at least one selected from a group of:
an RS configured for use in determining a position of a User Equipment, UE, of the RAN;
a downlink, DL, RS;
a Positioning Reference Signal, PRS;
an uplink, UL, RS; and
a Sounding Reference Signal, SRS.

43. The method of claim 41, wherein the first frequency range is within at least one selected from a group of:
a frequency range or band licensed for use by the RAN;
a frequency range or band of a New Radio, NR, spectrum;
a frequency range or band licensed for 5th Generation, 5G, NR;
a frequency range or band where access to the frequency range or band is planned and/or cannot be accessed opportunistically; and
a frequency range or band where a performance of a Listen Before Talk, LBT, procedure is not required for a transmission therein.

44. The method of claim 41, wherein the second frequency range is within at least one selected from a group of:
a frequency range or band unlicensed for use by the RAN;
a frequency range or band of a New Radio Unlicensed, NR-U, spectrum;
a frequency range or band not licensed for 5th Generation, 5G, NR;
a frequency range or band where access to the frequency range or band is unplanned and/or is accessed opportunistically; and
a frequency range or band where a performance of a Listen Before Talk, LBT, protocol is required for a transmission therein.

45. The method of claim 41, wherein the configuration information comprises an indication of first information for enabling the apparatus to determine at least one selected from a group of:
resources for the at least one first RS and the at least one second RS of the set of RSs;
a time, a frequency, a space, and/or a code for use with the at least one first RS and the at least one second RS of the set of RSs;
a pattern, a sequence, an order and/or an interleaving of the at least one first RS and the at least one second RS of the set of RSs;
a Listen Before Talk, LBT, protocol to implement for the transmission of the at least one second RS of the set of RSs;
a number of repetitions of the transmission or reception of the set of RSs; and
a periodicity of repetitions of the transmission or reception of the set of RSs.

46. The method of claim 41, wherein the configuration information comprises an indication of second information for enabling the apparatus to determine at least one selected from a group of the following parameters to be use for the transmission or reception of the at least first and/or second RS:
a sequence type;
a carrier frequency;
a time offset;
a bandwidth;
a frequency offset;
a repetition pattern;
a period; and
a comb.

47. The method of claim 41, further comprising:
responsive to receipt of a trigger, causing the transmission or the reception of the set of RSs to or from the at least one node of the RAN in accordance with the configuration information.

48. A non-transitory computer readable medium encoded with instructions that, when performed by at least one processor, causes at least the following to be perform:
receiving configuration information, wherein the configuration information comprises information for configuring a transmission or a reception, by the apparatus to or from at least one node a Radio Access Network, RAN, of a set of Reference Signals, RSs; wherein the set of RSs comprises:
at least a first RS to be transmitted or received within a first frequency range, and
at least a second RS to be transmitted or received within a second frequency range; and
based at least in part on the configuration information, causing the transmission or the reception of the set of RSs to or from the at least one node of the RAN.

49. The non-transitory computer readable medium of claim 48, wherein the at least first RS and/or the at least second RS is at least one selected from a group of:
an RS configured for use in determining a position of a User Equipment, UE, of the RAN;
a downlink, DL, RS;
a Positioning Reference Signal, PRS;
an uplink, UL, RS; and
a Sounding Reference Signal, SRS.

50. The non-transitory computer readable medium of claim 48, wherein the first frequency range is within at least one selected from a group of:
a frequency range or band licensed for use by the RAN;
a frequency range or band of a New Radio, NR, spectrum;
a frequency range or band licensed for 5th Generation, 5G, NR;
a frequency range or band where access to the frequency range or band is planned and/or cannot be accessed opportunistically; and
a frequency range or band where a performance of a Listen Before Talk, LBT, procedure is not required for a transmission therein.

51. The non-transitory computer readable medium of claim 48, wherein the second frequency range is within at least one selected from a group of:
a frequency range or band unlicensed for use by the RAN;
a frequency range or band of a New Radio Unlicensed, NR-U, spectrum;
a frequency range or band not licensed for 5th Generation, 5G, NR;
a frequency range or band where access to the frequency range or band is unplanned and/or is accessed opportunistically; and
a frequency range or band where a performance of a Listen Before Talk, LBT, protocol is required for a transmission therein.

52. non-transitory computer readable medium of claim 48, wherein the configuration information comprises an indication of first information for enabling the apparatus to determine at least one selected from a group of:
resources for the at least one first RS and the at least one second RS of the set of RSs;
a time, a frequency, a space, and/or a code for use with the at least one first RS and the at least one second RS of the set of RSs;
a pattern, a sequence, an order and/or an interleaving of the at least one first RS and the at least one second RS of the set of RSs;
a Listen Before Talk, LBT, protocol to implement for the transmission of the at least one second RS of the set of RSs;
a number of repetitions of the transmission or reception of the set of RSs; and
a periodicity of repetitions of the transmission or reception of the set of RSs.

53. The non-transitory computer readable medium of claim 48, wherein the configuration information comprises an indication of second information for enabling the apparatus to determine at least one selected from a group of the following parameters to be use for the transmission or reception of the at least first and/or second RS:
a sequence type;
a carrier frequency;
a time offset;
a bandwidth;
a frequency offset;
a repetition pattern;
a period; and
a comb.
